(19) United States
(12) Patent Application Publication
(10) Pub. No.: US 2026/0088342 A1
(43) Pub. Date: Mar. 26, 2026

(54) COMPOSITE CERAMIC ELECTROLYTE PARTICLE WITH HYDROPHOBIC PROTECTIVE LAYER FOR BATTERY ELECTRODE

(71) Applicant: ZHI FENG LUO, Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 18/896,967

(22) Filed: Sep. 26, 2024

(51) Int. Cl. H01M 10/0562; H01M 10/0525

(52) U.S. Cl. CPC H01M 10/0562; H01M 10/0525; H01M 2300/0071

(57) ABSTRACT

A composite ceramic electrolyte particle with a hydrophobic protective layer for a battery electrode, wherein the composite ceramic electrolyte particle is a composite LLZO particle. The composite LLZO particle includes a first LLZO particle. A first hydroxide ion layer is coated on the first LLZO particle to form a second order LLZO composite particle. A first dopamine layer is coated on the second order LLZO composite particle to form a hydrophobic LLZO particle. An outer hydrophobic layer is coated on the hydrophobic LLZO particle to form the composite LLZO particle. The outer hydrophobic layer includes a plurality of peripheral composite particles. Each of the peripheral composite particles includes a peripheral particle. A second hydroxide ion layer is coated on the peripheral particle. A second dopamine layer is coated on the second hydroxide ion layer.

### FIELD OF THE INVENTION

The present invention is related to a battery electrode material, and in particular to a composite ceramic electrolyte particle with a hydrophobic protective layer for a battery electrode.

### BACKGROUND OF THE INVENTION

A typical battery is formed by the electrodes (positive and negative) placed in an electrolyte. In the prior art, LLZO (lithium lanthanum zirconium oxide) material is added into the electrodes to increase the ionic conductivity. Because LLZO particles has a high ionic conductivity for lithium ions, when lithium ions pass through the electrode, in particular a negative electrode, the lithium ions can be dispersed by the guiding of the dispersed LLZO particles. Therefore, the lithium ions can be evenly distributed inside the negative electrode, which avoids the abnormal accumulation of lithium ions in the negative electrode slurry to cause a side reaction.

However, moisture exists during the manufacturing process of the electrode, and the LLZO particle is hydrophilic and is easy to be dampened to form an alkali by the reaction with the water, resulting in deterioration of the material in the negative electrode slurry.

### SUMMARY OF THE INVENTION

Accordingly, for improving above mentioned defects in the prior art, the object of the present invention is to provide a composite ceramic electrolyte particle with a hydrophobic protective layer for a battery electrode, wherein a first LLZO particle is coated with a first dopamine layer to form a hydrophobic LLZO particle. The hydrophobic LLZO particle is further coated with barium titanate composite particles or zinc oxide composite particles having a second dopamine layer to form a composite LLZO particle, which has a better ionic conductivity. The dopamine layer is hydrophobic and serves to prevent the external water from entering into the first LLZO particle. The barium titanate composite particles and zinc oxide composite particles also are hydrophobic and can provide a further protection for the first LLZO particle. The composite LLZO particle is further coated with the auxiliary agent including carbon nanotubes and nanoscale amorphous carbons to increase the lithium ion conductivity, wherein the nanoscale amorphous carbons are filled in the gaps of the carbon nanotubes to increase the electrical conductivity. The barium titanate composite particles, zinc oxide composite particles, dopamine layer, carbon nanotubes and nanoscale amorphous carbons form multiple protective structures for the first LLZO particle, which increases the lithium-conducting property of the first LLZO particle, avoids reactions of the first LLZO particle and the water in the manufacturing of the electrode, and achieves a better quality in battery electrode material manufacturing.

To achieve above object, the present invention provides a composite ceramic electrolyte particle with a hydrophobic protective layer for a battery electrode; the composite ceramic electrolyte particle being a composite LLZO particle; the battery electrode being an electrode of a solid-state or semi-solid battery; the electrode including a substrate for carrying the material of the electrode, and an electrode slurry layer coated on the substrate; the composite LLZO particle comprising: a first LLZO particle serving to guide and disperse paths of lithium ions, and to cause that evenly distributed lithium ion channels are formed inside the electrode; a first hydroxide ion layer coated on an outer surface of the first LLZO particle; the first hydroxide ion layer and the first LLZO particle forming a second order LLZO composite particle; the first hydroxide ion layer being formed by a reaction of tris (tris(hydroxymethyl)aminomethane, (HOCH₂)₃CNH₂) molecules and has a plurality of third OH⁻ions; the tris molecules being added in the manufacturing process of the composite LLZO particle; each of the tris molecules having three OH⁻ions which are a first OH⁻ion, a second OH-ion and the third OH⁻ion; the first ions and the second OH^{—}ions of the tris molecules being bound to oxidizing functional groups on the first LLZO particle by hydrogen bonding; the third OH⁻ions of the tris molecules extending outward to an outer side of the first LLZO particle to form the first hydroxide ion layer; a first dopamine layer coated on an outer side of the second order LLZO composite particle; the first dopamine layer and the second order LLZO composite particle forming a hydrophobic LLZO particle; the first dopamine layer being formed by a plurality of dopamine molecules copolymerized; a polymerization triggered by dehydration being performed between OH⁻ions of the dopamine molecules of the first dopamine layer and the third OH^{—}ions of the first hydroxide ion layer to cause that the first dopamine layer is connected to the second order LLZO composite particle through the first hydroxide ion layer; the dopamine molecules of the dopamine layer being hydrophobic to protect the first LLZO particle and to prevent the first LLZO particle from being dampened; an outer hydrophobic layer coated on an outer surface of the hydrophobic LLZO particle; the outer hydrophobic layer and the hydrophobic LLZO particle forming the composite LLZO particle; the outer hydrophobic layer including a plurality of peripheral composite particles; each of the peripheral composite particles being selected from a barium titanate (BaTiO₃) composite particle and a zinc oxide (ZnO) composite particle; wherein each of the peripheral composite particles includes a peripheral particle; when the peripheral composite particle is the barium titanate composite particle, the peripheral particle is a barium titanate particle; when the peripheral composite particle is the zinc oxide composite particle, the peripheral particle is a zinc oxide particle; a second hydroxide ion layer is coated on an outer side of the peripheral particle; and a second dopamine layer is coated on an outer side of the second hydroxide ion layer; wherein the second hydroxide ion layer is formed by a reaction of the tris (tris(hydroxymethyl)aminomethane, (HOCH₂)₃CNH₂) molecules and has a plurality of third OH⁻ions; the tris molecules are added in the manufacturing process of the composite LLZO particle; each of the tris molecules has three OH⁻ions which are the first OH⁻ion, the second OH⁻ion and the third OH⁻ion; the first ions and second OH⁻ions of the tris molecules are bound to oxidizing functional groups on a corresponding barium titanate particle or zinc oxide particle by hydrogen bonding; the third OH⁻ions of the tris molecules extend outward to an outer side of the corresponding barium titanate particle or zinc oxide particle to form the second hydroxide ion layer; wherein the second dopamine layer is formed by a plurality of dopamine molecules copolymerized; a polymerization triggered by dehydration is performed between OH⁻ions of the dopamine molecules of the second dopamine layer and the third OH⁻ions of a corresponding second hydroxide ion layer to cause that the second dopamine layer is connected to a corresponding barium titanate particle or zinc oxide particle through the corresponding second hydroxide ion layer; and wherein the outer hydrophobic layer is coated on the outer surface of the hydrophobic LLZO particle by chain co-polymerization of the dopamine molecules of the first dopamine layer and the dopamine molecules of the second dopamine layer on the outer hydrophobic layer.

### BRIEF DESCRIPTION OF THE DRAWINGS

FIG. 1 is a schematic view showing the structure of the composite LLZO particle of the present invention.

FIG. 2 shows an application of the structure of the present invention.

FIG. 3 is a schematic view showing the full structure and a partial structure of the second order LLZO composite particle of the present invention.

FIG. 4 is a schematic view showing the full structure and the partial structure of the hydrophobic LLZO particle, wherein the polymerization triggered by dehydration is formed between the OH⁻ion of the dopamine of the first dopamine layer and the third OH⁻ion of the first hydroxide ion layer.

FIG. 5 is a schematic view showing the full structure and the partial structure of the barium titanate composite particle of the present invention.

FIG. 6 is a schematic view showing the full structure and the partial structure of the zinc oxide composite particle of the present invention.

FIG. 7 is a schematic view showing the structure of the third order LLZO composite particle of the present invention.

FIG. 8 is a cross-section view showing the structure of the composite LLZO particle of the present invention.

FIG. 9 is a cross-section view showing the partial structure of the composite LLZO particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

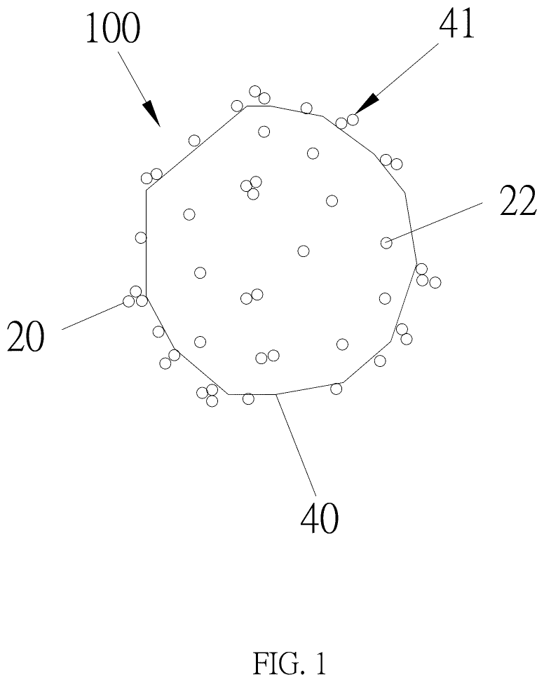

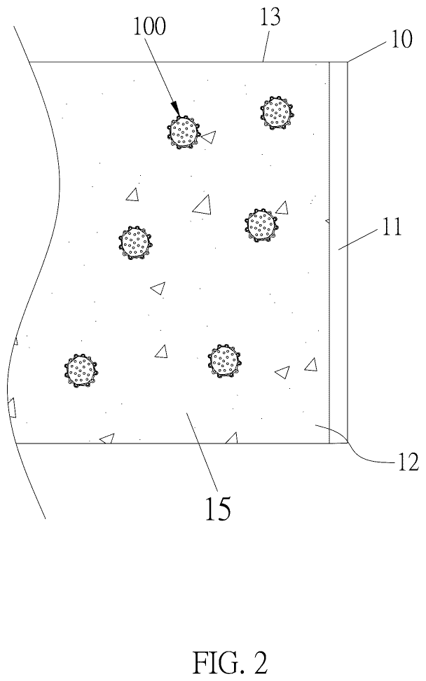

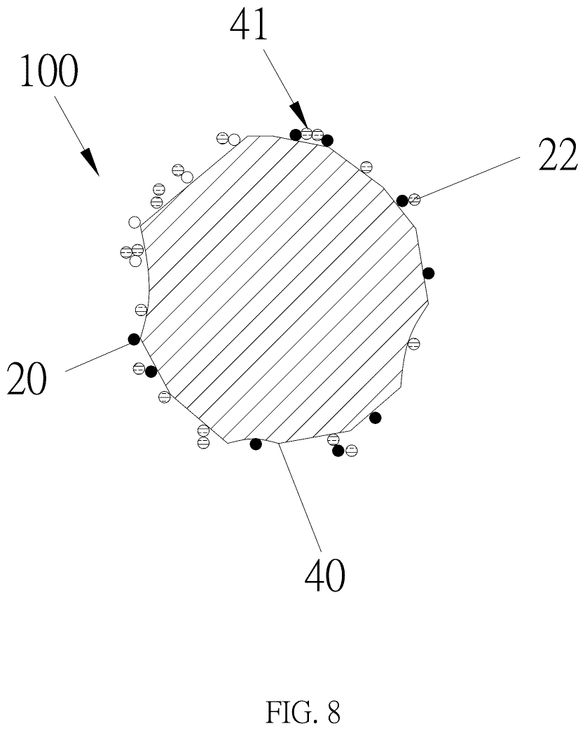

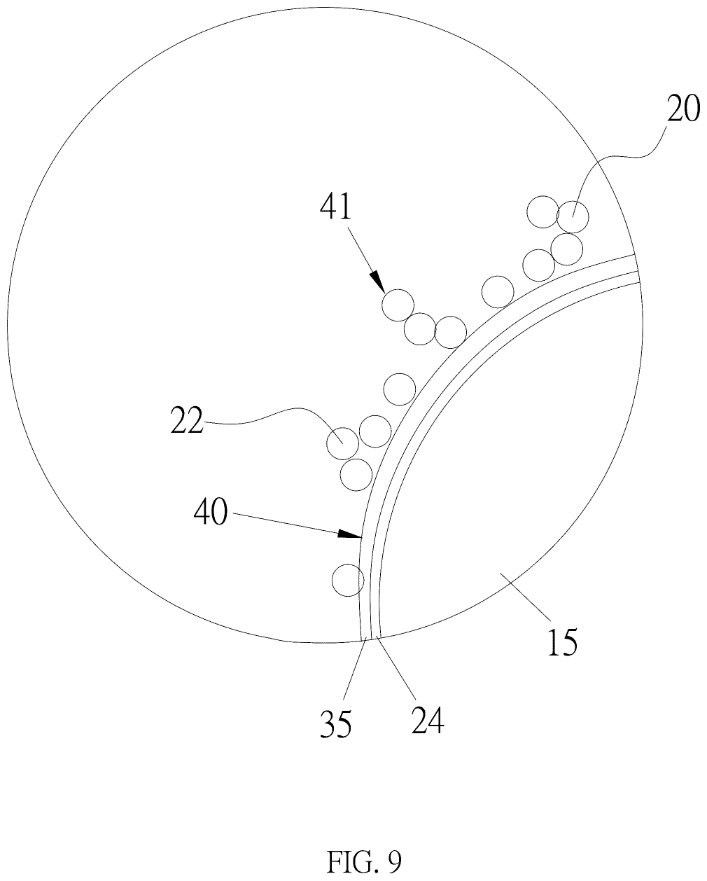

With reference to FIGS. 1 to 9, the present invention provides a composite ceramic electrolyte particle with a hydrophobic protective layer for a battery electrode. The composite ceramic electrolyte particle is a composite LLZO particle 100. The composite LLZO particle 100 is used in the battery electrode and the battery electrode is an electrode 10 of a solid-state or semi-solid battery. In the application, a plurality of composite LLZO particles 100 can be added into the electrode 10, wherein the electrode 10 is in particular a negative electrode of the solid-state or semi-solid battery. A size of the composite LLZO particle 100 is 50 nm to 200 nm. The electrode 10 includes a substrate 11 for carrying the material of the electrode 10, and an electrode slurry layer 13 coated on the substrate 11. The electrode slurry layer 13 includes the composite LLZO particles 100 and an electrode slurry 12 which is used as a binder. The electrode slurry 12 is formed by at least one of styrene-butadiene rubber (SBR), carboxymethyl cellulose (CMC) and auxiliary agent (carbon nanotube or Super-P (comductive carbon black)). A weight percentage of the composite LLZO particles 100 in an electrode slurry layer 13 (in particular a negative electrode slurry layer) is 0.5wt %˜5wt %.

The composite LLZO particle 100 includes the following elements.

A first LLZO particle 15. Since LLZO material has a high ionic conductivity, when lithium ions pass through the electrode, the first LLZO particle 15 serves to guide and disperse paths of the lithium ions, and to cause that evenly distributed lithium ion channels are formed inside the electrode, which avoids the abnormal accumulation of lithium ions in the electrode slurry to cause a side reaction.

The first LLZO particle 15 is formed by LLZO (lithium lanthanum zirconium oxide, Li₇La₃Zr₂O₁₂) or LLZO doped with at least one metal (such as gallium(Ga)-doped LLZO (Li_{6.2}Ga_{0.8}La₃Zr₂O₁₂), aluminum(Al)-doped LLZO or barium(Ba)-doped LLZO.

Since moisture exists during the manufacturing process of the electrode, and the LLZO particles are hydrophilic and is easy to be dampened to form an alkali. Therefore, in the present invention, an outer side of the first LLZO particle 15 is coated with a protective layer (the following first dopamine layer 35) to prevent the first LLZO particle 15 from being dampened during the manufacturing process of the electrode.

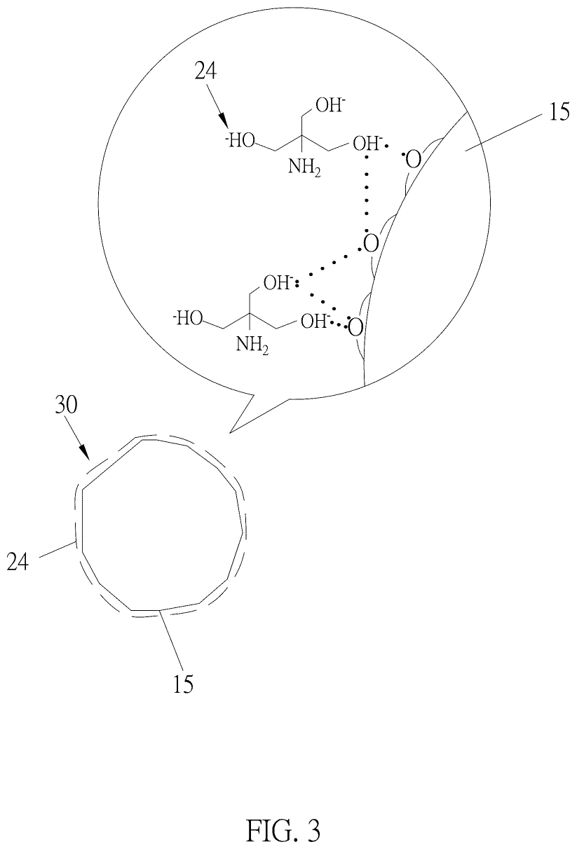

A first hydroxide ion (OH⁻) layer 24 is coated on an outer surface of the first LLZO particle 15. The first hydroxide ion layer 24 and the first LLZO particle 15 form a second order LLZO composite particle 30 (as shown in FIG. 3). A thickness of the first hydroxide ion layer 24 is 0.5 nm˜2 nm. The first hydroxide ion layer 24 is formed by a reaction of tris (tris(hydroxymethyl)aminomethane, (HOCH₂)₃CNH₂) molecules and has a plurality of third OH⁻ions. The tris molecules are added in the manufacturing process of the composite LLZO particle 100. Each of the tris molecules has three OH⁻ions which are a first OH⁻ion, a second OH-ion and the third OH⁻ion. The first and second OH⁻ions are bound to oxidizing functional groups on the first LLZO particle 15 by hydrogen bonding. The third OH⁻ion extends outward to an outer side of the first LLZO particle 15 to form the first hydroxide ion layer 24. FIG. 3 shows an example of only two tris molecules and is not used to limit the scope of the present invention.

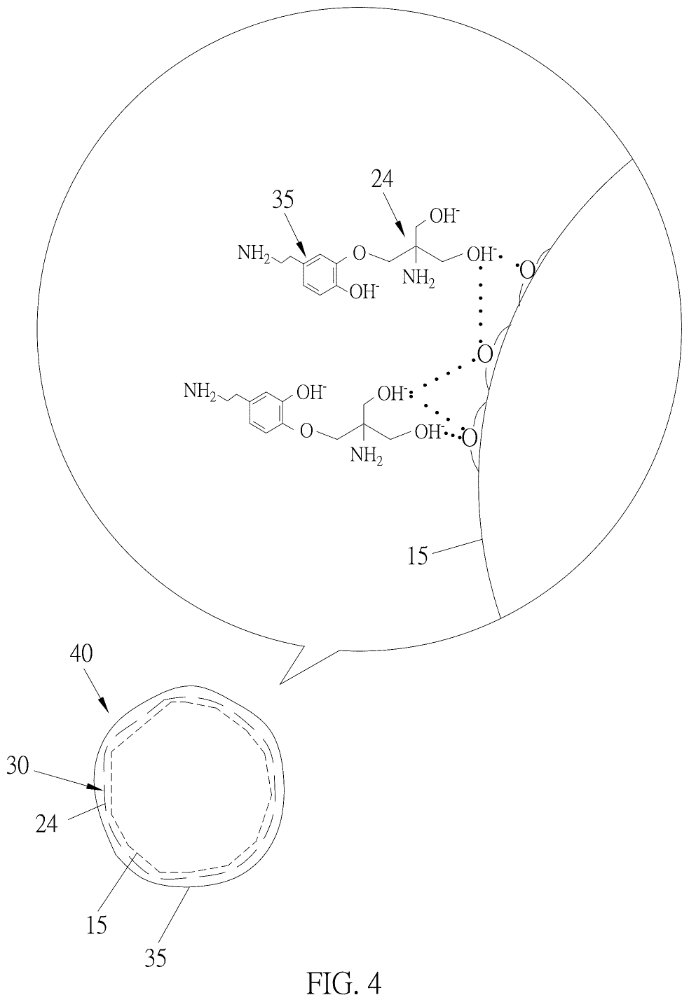

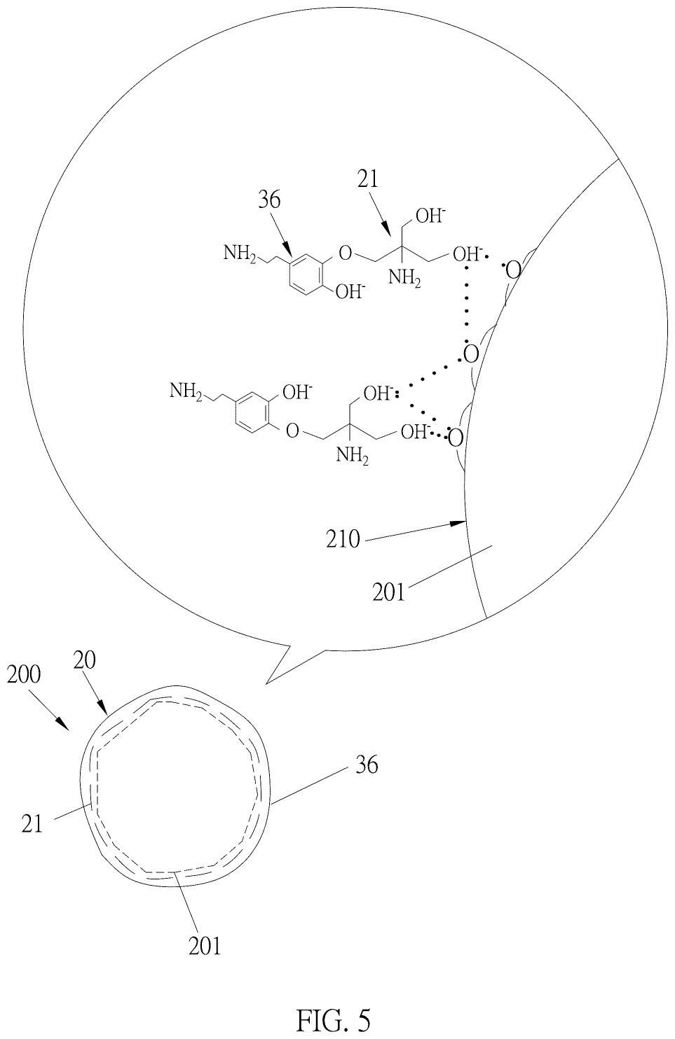

A first dopamine layer 35 is coated on an outer side of the second order LLZO composite particle 30. The first dopamine layer 35 and the second order LLZO composite particle 30 form a hydrophobic LLZO particle 40 (as shown in FIG. 4). The first dopamine layer 35 is formed by a plurality of dopamine molecules copolymerized. A polymerization triggered by dehydration is performed between an OH⁻ion of each of the dopamine molecules of the first dopamine layer 35 and a respective one third OH⁻ion of the first hydroxide ion layer 24 to cause that the first dopamine layer 35 is connected to the second order LLZO composite particle 30 through the first hydroxide ion layer 24 (as shown in FIG. 5). A thickness of the first dopamine layer 35 is 1 nm˜10 nm.

Since moisture exists during the manufacturing process of the electrode slurry, and the LLZO particles are hydrophilic and is easy to be dampened to form an alkali which destroys the lithium-conducting property of the LLZO particle. Therefore, the dopamine is used in the present invention. The dopamine molecules of the dopamine layer 35 are hydrophobic to protect the first LLZO particle 15 and to prevent the first LLZO particle 15 from being dampened.

An outer hydrophobic layer 41 is coated on an outer surface of the hydrophobic LLZO particle 40. The outer hydrophobic layer 41 and the hydrophobic LLZO particle 40 form the composite LLZO particle 100 (as shown in FIG. 1). The outer hydrophobic layer 41 includes a plurality of peripheral composite particles 200. Each of the peripheral composite particles 200 is selected from a barium titanate (BaTiO₃) composite particle 20 and a zinc oxide (ZnO) composite particle 22. The peripheral composite particles 200 distributed on the outer surface of the hydrophobic LLZO particle 40 are a naturally formed structure formed in the stirring of manufacturing process.

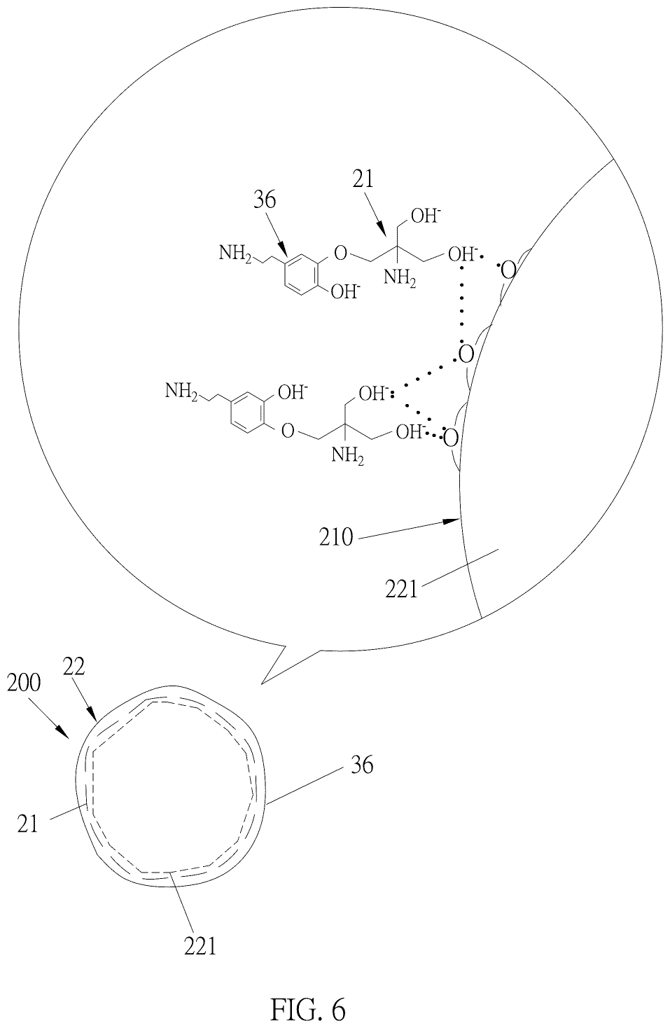

Referring to FIGS. 5 and 6, each of the peripheral composite particles 200 includes a peripheral particle 210. When the peripheral composite particle 200 is the barium titanate composite particle 20, the peripheral particle 210 is a barium titanate particle 201. When the peripheral composite particle 200 is the zinc oxide composite particle 22, the peripheral particle 210 is a zinc oxide particle 221. A second hydroxide ion (OH⁻) layer 21 is coated on an outer side of the peripheral particle 210. A second dopamine layer 36 is coated on an outer side of the second hydroxide ion layer 21. A size of each of the barium titanate composite particle 20 and the zinc oxide composite particle 22 is 10 nm˜20 nm.

The second hydroxide ion layer 21 is formed by a reaction of the tris (tris(hydroxymethyl)aminomethane, (HOCH₂)₃CNH₂) molecules and has a plurality of third OH⁻ions. The tris molecules are added in the manufacturing process of the composite LLZO particle 100. Each of the tris molecules has three OH⁻ions which are the first OH⁻ion, the second OH⁻ion and the third OH⁻ion. The first ions and the second OH⁻ions of the tris molecules are bound to oxidizing functional groups on a corresponding barium titanate particle 201 or zinc oxide particle 221 by hydrogen bonding. The third OH⁻ions of the tris molecules extend outward to an outer side of the corresponding barium titanate particle 201 or zinc oxide particle 221 to form the second hydroxide ion layer 21. FIGS. 5 and 6 show examples of only two tris molecules and are not used to limit the scope of the present invention.

The second dopamine layer 36 is formed by a plurality of dopamine molecules copolymerized. A polymerization triggered by dehydration is performed between OH⁻ions of the dopamine molecules of the second dopamine layer 36 and the third OH⁻ions of a corresponding second hydroxide ion layer 21 to cause that the second dopamine layer 36 is connected to a corresponding barium titanate particle 201 or zinc oxide particle 221 through the corresponding second hydroxide ion layer 21 (as shown in FIGS. 5 and 6).

A ratio of a weight of the outer hydrophobic layer 41 and a weight of the hydrophobic LLZO particle 40 is 1/25˜ 1/10 (4%˜10%). A thickness of the second hydroxide ion layer 21 is 0.5 nm˜2 nm. A thickness of the second dopamine layer 36 is 1 nm˜10 nm.

The outer hydrophobic layer 41 is coated on the outer surface of the hydrophobic LLZO particle 40 by chain co-polymerization of the dopamine molecules of the first dopamine layer 35 and the dopamine molecules of the second dopamine layer 36 on the outer hydrophobic layer 41, which is a naturally formed structure formed in the stirring of manufacturing process.

The purpose of coating the outer hydrophobic layer 41 is that, since the barium titanate particle 201 and zinc oxide particle 221 are hydrophobic, the barium titanate particle 201 and zinc oxide particle 221 serve to isolate an external water and the first LLZO particle 15 when they are coated on the outer surface of the hydrophobic LLZO particle 40, which prevent the first LLZO particle 15 from being dampened. Moreover, the ionic conductivity of the barium titanate particle 201 is higher than that of the first LLZO particle 15, therefore the barium titanate particle 201 can also provide a better ionic conductivity. The zinc oxide particle 221 serves to enhance the electrode compatibility and to be used as an ionic interface layer, and it has the function of the electrode material, which can reduce the loss of capacitance due to the coating.

The purpose of coating the second hydroxide ion layer 21 on the outer surface of the peripheral particle 210 is that, since the barium titanate particle 201 and zinc oxide particle 221 are insoluble in water and the hydroxide ions (OH⁻ions) on the second hydroxide ion layer 21 has a polarity, by coating the second hydroxide ion layer 21 on the outer side of the barium titanate particle 201 and the zinc oxide particle 221, the second dopamine layer 36 can react with the second hydroxide ion layer 21 and can be more stably attached on the barium titanate particle 201 and the zinc oxide particle 221.

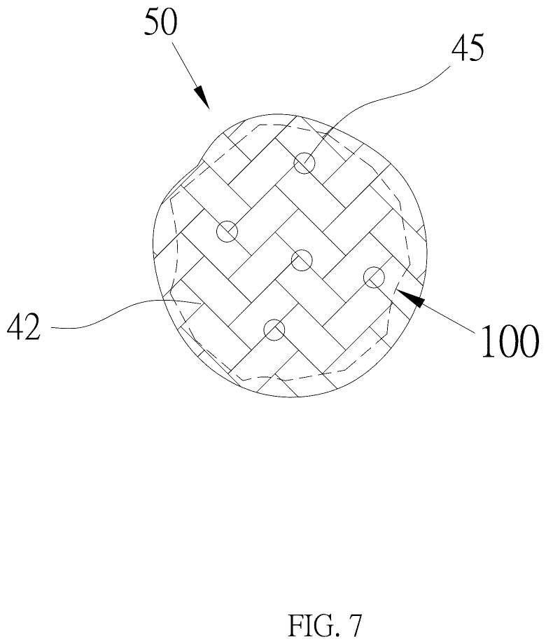

A plurality of carbon nanotubes 42 and a plurality of nanoscale amorphous carbons 45 are coated on an outer side of the composite LLZO particle 100. The carbon nanotubes 42, the nanoscale amorphous carbons 45 and the composite LLZO particle 100 form a third order LLZO composite particle 50 (as shown in FIG. 7). A size of each of the carbon nanotubes 42 is 200 nm˜500 nm. A size of each of the nanoscale amorphous carbons 45 is 10 nm˜40 nm. Preferably, the nanoscale amorphous carbons 45 are amorphous carbons of a Super P auxiliary agent.

A ratio of a total weight of the carbon nanotubes 42 and the nanoscale amorphous carbons 45 and a weight of the first LLZO particle 15 is 0.2˜2:99.8˜98.

The carbon nanotubes 42 and the nanoscale amorphous carbons 45 are used as an auxiliary agent. Because the nanoscale amorphous carbons 45 are in a form of particles, and the carbon nanotubes 42 are in a form of long strips, a plurality of gaps are formed in the interleaving structure formed by the carbon nanotubes 42 and are unable to conduct the electric current. Therefore, the nanoscale amorphous carbons 45 are filled in the gaps to transmit the electric charge between the carbon nanotubes 42 through the spanning of the nanoscale amorphous carbons 35, which further increases the transmitting efficiency of the electric current. The composite LLZO particle 100 coated with the carbon nanotubes 42 has a hairball-like structure (as shown in FIG. 7).

The advantages of the carbon nanotubes 42 are that the lithium ions are easy to be stabilized between the carbon nanotubes 42, therefore the lithium ion conductivity can be increased. The very high lithium ion conductivity helps the whole battery to charge and discharge quickly. In addition, the use of cobalt also can be reduced, so that the overall production cost can be reduced.

The advantages of the present invention are that a first LLZO particle is coated with a first dopamine layer to form a hydrophobic LLZO particle. The hydrophobic LLZO particle is further coated with barium titanate composite particles or zinc oxide composite particles having a second dopamine layer to form a composite LLZO particle, which has a better ionic conductivity. The dopamine layer is hydrophobic and serves to prevent the external water from entering into the first LLZO particle. The barium titanate composite particles and zinc oxide composite particles also are hydrophobic and can provide a further protection for the first LLZO particle. The composite LLZO particle is further coated with the auxiliary agent including carbon nanotubes and nanoscale amorphous carbons to increase the lithium ion conductivity, wherein the nanoscale amorphous carbons are filled in the gaps of the carbon nanotubes to increase the electrical conductivity. The barium titanate composite particles, zinc oxide composite particles, dopamine layer, carbon nanotubes and nanoscale amorphous carbons form multiple protective structures for the first LLZO particle, which increases the lithium-conducting property of the first LLZO particle, avoids reactions of the first LLZO particle and the water in the manufacturing of the electrode, and achieves a better quality in battery electrode material manufacturing.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A composite ceramic electrolyte particle with a hydrophobic protective layer for a battery electrode; the composite ceramic electrolyte particle being a composite LLZO particle; the battery electrode being an electrode of a solid-state or semi-solid battery; the electrode including a substrate for carrying the material of the electrode, and an electrode slurry layer coated on the substrate; the composite LLZO particle comprising:
a first LLZO particle serving to guide and disperse paths of lithium ions, and to cause that evenly distributed lithium ion channels are formed inside the electrode;
a first hydroxide ion layer coated on an outer surface of the first LLZO particle; the first hydroxide ion layer and the first LLZO particle forming a second order LLZO composite particle; the first hydroxide ion layer being formed by a reaction of tris (tris(hydroxymethyl)aminomethane, (HOCH₂)₃CNH₂) molecules and has a plurality of third OH⁻ions; the tris molecules being added in the manufacturing process of the composite LLZO particle; each of the tris molecules having three OH⁻ions which are a first OH⁻ion, a second OH⁻ion and the third OH⁻ion; the first ions and the second OH⁻ions of the tris molecules being bound to oxidizing functional groups on the first LLZO particle by hydrogen bonding; the third OH⁻ions of the tris molecules extending outward to an outer side of the first LLZO particle to form the first hydroxide ion layer;
a first dopamine layer coated on an outer side of the second order LLZO composite particle; the first dopamine layer and the second order LLZO composite particle forming a hydrophobic LLZO particle; the first dopamine layer being formed by a plurality of dopamine molecules copolymerized; a polymerization triggered by dehydration being performed between OH⁻ions of the dopamine molecules of the first dopamine layer and the third OH⁻ions of the first hydroxide ion layer to cause that the first dopamine layer is connected to the second order LLZO composite particle through the first hydroxide ion layer; the dopamine molecules of the dopamine layer being hydrophobic to protect the first LLZO particle and to prevent the first LLZO particle from being dampened;
an outer hydrophobic layer coated on an outer surface of the hydrophobic LLZO particle; the outer hydrophobic layer and the hydrophobic LLZO particle forming the composite LLZO particle; the outer hydrophobic layer including a plurality of peripheral composite particles; each of the peripheral composite particles being selected from a barium titanate (BaTiO₃) composite particle and a zinc oxide (ZnO) composite particle;
wherein each of the peripheral composite particles includes a peripheral particle; when the peripheral composite particle is the barium titanate composite particle, the peripheral particle is a barium titanate particle; when the peripheral composite particle is the zinc oxide composite particle, the peripheral particle is a zinc oxide particle; a second hydroxide ion layer is coated on an outer side of the peripheral particle; and a second dopamine layer is coated on an outer side of the second hydroxide ion layer;
wherein the second hydroxide ion layer is formed by a reaction of the tris (tris(hydroxymethyl)aminomethane, (HOCH₂)₃CNH₂) molecules and has a plurality of third OH⁻ions; the tris molecules are added in the manufacturing process of the composite LLZO particle; each of the tris molecules has three OH⁻ions which are the first OH⁻ion, the second OH⁻ion and the third OH⁻ion; the first ions and second OH⁻ions of the tris molecules are bound to oxidizing functional groups on a corresponding barium titanate particle or zinc oxide particle by hydrogen bonding; the third OH⁻ions of the tris molecules extend outward to an outer side of the corresponding barium titanate particle or zinc oxide particle to form the second hydroxide ion layer;
wherein the second dopamine layer is formed by a plurality of dopamine molecules copolymerized; a polymerization triggered by dehydration is performed between OH⁻ions of the dopamine molecules of the second dopamine layer and the third OH⁻ions of a corresponding second hydroxide ion layer to cause that the second dopamine layer is connected to a corresponding barium titanate particle or zinc oxide particle through the corresponding second hydroxide ion layer; and
wherein the outer hydrophobic layer is coated on the outer surface of the hydrophobic LLZO particle by chain co-polymerization of the dopamine molecules of the first dopamine layer and the dopamine molecules of the second dopamine layer on the outer hydrophobic layer.

2. The composite ceramic electrolyte particle with the hydrophobic protective layer for the battery electrode as claimed in claim 1, wherein the first LLZO particle is formed by LLZO (lithium lanthanum zirconium oxide, Li₇La₃Zr₂O₁₂) or LLZO doped with at least one metal.

3. The composite ceramic electrolyte particle with the hydrophobic protective layer for the battery electrode as claimed in claim 1, wherein a ratio of a weight of the outer hydrophobic layer and a weight of the hydrophobic LLZO particle is 1/25˜ 1/10.

4. The composite ceramic electrolyte particle with the hydrophobic protective layer for the battery electrode as claimed in claim 1, wherein the composite LLZO particle is used in a negative electrode.

5. The composite ceramic electrolyte particle with the hydrophobic protective layer for the battery electrode as claimed in claim 1, wherein a size of the composite LLZO particle is 50 nm to 200 nm.

6. The composite ceramic electrolyte particle with the hydrophobic protective layer for the battery electrode as claimed in claim 1, wherein a size of each of the barium titanate composite particle and the zinc oxide composite particle is 10 nm˜20 nm.

7. The composite ceramic electrolyte particle with the hydrophobic protective layer for the battery electrode as claimed in claim 1, wherein a thickness of the first hydroxide ion layer is 0.5 nm˜2 nm; and a thickness of the second hydroxide ion layer is 0.5 nm˜2 nm.

8. The composite ceramic electrolyte particle with the hydrophobic protective layer for the battery electrode as claimed in claim 1, wherein a thickness of the first dopamine layer is 1 nm˜10 nm; and a thickness of the second dopamine layer is 1 nm˜10 nm.

9. The composite ceramic electrolyte particle with the hydrophobic protective layer for the battery electrode as claimed in claim 1, wherein a plurality of carbon nanotubes and a plurality of nanoscale amorphous carbons are coated on an outer side of the composite LLZO particle; and the carbon nanotubes, the nanoscale amorphous carbons and the composite LLZO particle form a third order LLZO composite particle.

10. The composite ceramic electrolyte particle with the hydrophobic protective layer for the battery electrode as claimed in claim 9, wherein a size of each of the carbon nanotubes is 200 nm˜500 nm; and size of each of the nanoscale amorphous carbons is 10 nm˜40 nm.

11. The composite ceramic electrolyte particle with the hydrophobic protective layer for the battery electrode as claimed in claim 9, wherein a ratio of a total weight of the carbon nanotubes and the nanoscale amorphous carbons and a weight of the first LLZO particle is 0.2˜2:99.8˜98.
